(19) United States
(12) Patent Application Publication
(10) Pub. No.: US 2001/0052849 A1
(43) Pub. Date: Dec. 20, 2001

(54) Wearable location monitoring and communications system

(76) Inventor: Thomas Henry Jones JR., Madison, MS (US)

Correspondence Address: BRADLEY ARANT ROSE & WHITE, LLP, 2001 PARK PLACE, SUITE 1400, BIRMINGHAM, AL, 352032736

(21) Appl. No.: 09/842,360

(22) Filed: Apr. 24, 2001

Related U.S. Application Data
(60) Provisional application No. 60/199,848, filed on Apr. 26, 2000.

(51) Int. Cl. G08B 21/00

(52) U.S. Cl. 340/572.1; 340/540

(57) ABSTRACT

A system and method for monitoring from variable endpoints the location of a remote wearer of a wireless communications device is disclosed. The device is capable of determining its current geographic location from GPS signals or the like and comparing such location to a stored set of rules defining permissible or impermissible geographic zones. Upon breach of such rules, the device will automatically report notification of the breach to a central server which will communicate notification to a designated endpoint based on previously stored routing conditions. Endpoints are capable of querying or sending a message to the device directly. Further, the system provides for a network-accessible communications center, such as an Internet website, through which users of the system may send and receive data to the device, or modify the boundary rule sets or routing conditions as needed in near real time.

### PRIORITY CLAIM

This application claims the benefit of U.S. Provisional Application No. 60/199,848 titled CHILD MONITOR AND LOCATOR SYSTEM, filed Apr. 26, 2000.

### FIELD OF THE INVENTION

The present invention relates to the remote monitoring of a person's location through communications and GPS technology.

### BACKGROUND OF THE INVENTION

Location systems that allow for the maintenance of an individual are typically implemented in one of two genre. Either the system is based on a localized transceiver, with the power of the transmitted or received signal used to estimate the distance from a central point, and therefore the maintenance of the locale; or the system uses the same transceiver to triangulate location from a set of local transceivers. Alternatively, the systems are implemented with a wide area transceiver and a global positioning systems (GPS) receiver, and location is transmitted to a central database either based on time or based on distance traveled from the last position. This position is periodically transmitted to a central location and processed with mapping systems to providing a street level location. These two systems and their permutations are currently known in the art.

With all systems of this kind, the tradeoff between a constantly updated location and a wide area of coverage has been the limiting economic factor. With the expansion of commercial wide area wireless data communications systems (i.e., two-way paging, cellular TDMA and CDMA, et al.) an economically feasible terrestrial network has been established to provide a communications mechanism through which an individual's location can be transmitted. Moreover, the expansion of the Internet has worldwide data network, and the merger of data and voice communications and interchangeability therebetween allow messages which may first enter a communications network wirelessly to be transmitted to nearly any place in the world through the Internet.

GPS has been the system of choice in providing a map-based location through the wireless networks. In most circumstances, however, there is no economically sound method to maintain adequate geographic location data without either sending data based on a period of time since the last update and therefore, depending on the period and velocity of the device, this could be significantly erroneous; or transmitting data nearly constantly, overcoming the time delay between fixes, but significantly increasing the operating cost of the system. Further, with the increasing mobility of society, the location of end users of the transmitted geographic information (e.g., parents) is not necessarily fixed. These users may need the information transmitted to one endpoint on one day, and a different endpoint on another day. Alternatively, the end user to whom the geographic information should be sent may depend on special circumstances with respect to the wearer of the device. The conditions determining who should receive the geographic information may need to be changed regularly.

Although technology has been made available to increase the accuracy of the GPS signal (location resolution), and wide area networks have become more commonplace on a worldwide basis, there is a need for a system to overcome the economics of a wide area capable system that provides for adequate resolution of location on an on-going basis and transmitting that location data to variable end users, according to their variable schedules or other circumstances.

### SUMMARY

The invention comprises a method of monitoring from a variable endpoint breaches of a boundary rule set by a remote wearer of a wireless communication device. The boundary rule set contains geographic boundaries which define inclusion or exclusion zones, and the rule set may include temporal rules defining the permissibility of certain geographic areas at specific times. The device includes memory, a processor, a GPS receiver, and a wireless transceiver. Thus, the device is capable of storing the boundary rule set, determining its current geographic location from the GPS signal, comparing the current location to the rule set to determine if said wearer has breached the rule set, and communicating notification of the breach to a communications network, including a wide area wireless network. The communications network preferably includes connectivity to the Internet. A server capable of receiving messages from the wireless communications device through the communications network contains the logical identity of at least one endpoint to which to send messages from the remote device. An endpoint can be any type of communications device, such as a pager, a telephone (including cellular, digital, other wireless, or traditional land-line telephone), a personal digital assistant, a computer, an electronic mail address, or internet messaging system, or any type of internet appliance now known or yet to be developed. Each such endpoint stored in the server has associated with it at least one routing condition. A routing condition defines when that particular endpoint is designated to receive notification of breach of the boundary rule set by the wearer of the device. Routing conditions may include time of day, day of week, geographic location of the wearer, altitude of the wearer, speed of the wearer's movement, direction of the wearer's movement, or a user-definable override condition. If the wearer of the device violates the boundary rule set, the device communicates notification of the breach to the server through the communications network. The notification contains at least one parameter of the breach, such as time of day, day of week, geographic location of the wearer, altitude of the wearer, speed of the wearer's movement, and direction of the wearer's movement. The server then determines which endpoint is designated to receive the notification by based on the parameters of the breach and the stored routing conditions, and communicates the notification to the designated endpoint.

### DESCRIPTION OF THE DRAWINGS

These and other features, aspects, structures, advantages, and functions are shown or inherent in, and will become better understood with regard to, the following description and accompanied drawings where:

FIG. 1 is a schematic diagram the basic architecture of an embodiment of the invention;

FIG. 2 is a schematic diagram of the components of the wireless communication device worn by the wearer depicted in FIG. 1;

FIG. 3 is a flowchart of the monitor logic of the wireless communication device of FIG. 2;

FIG. 4 is a flowchart of the setup logic for the wireless communication device of FIG. 2;

FIG. 5 is a flowchart of the logic for the internal validation check of the wireless communication device of FIG. 2;

FIG. 6 is a flowchart of the logic for the device message handlers of the wireless communication device of FIG. 2; and

FIG. 7 is a flowchart of the logic for the server depicted in FIG. 1.

### DETAILED DESCRIPTION OF A PREFERRED EMBODIMENT

The present invention determines with certainty that a person or object wearing a wireless communications device is either within or outside of certain, definable, and variable geographic limits on an on-going basis and communicates notifications of breaches of those limits to designated end users. The limits also may contain variable and updateable time components, which may be based for example on the subject's schedule or planned movement. The limits are referred to herein as boundary rule sets.

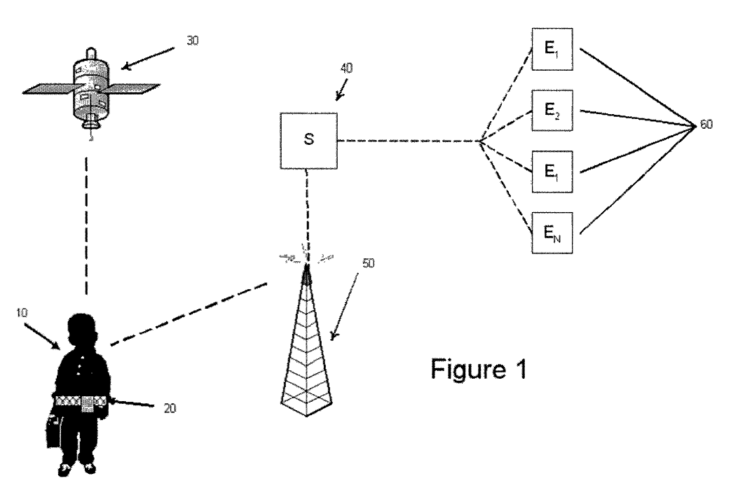

The basic architecture of the system is represented in FIG. 1. A person or object 10 (the “wearer”) wears or is otherwise fitted with a wireless communications device 20. The device 20 receives geographic locational data from a system of satellites 30 commonly referred to as the Global Positioning System or GPS. The device 20 is capable of storing a boundary rule set and transmitting notifications of breaches of the boundary rule set, as well as other messages, to a server 40. The device 20 typically communicates with the server 40 via a wireless transceiver and a wide area wireless network 50. As described in more detail below, the server 40 determines which of at least one endpoint 60 is designated to receive the current message and communicates the message to the designated endpoint. An endpoint is typically associated with a person (the “user”) interested in the wearer's geographic location, such as the wearer's parent or guardian. Depending on the type of device associated with an endpoint 60, such device (e.g., wireless digital telephone) may be able to query and communicate directly with device 20 without routing the signal through the server.

As noted, the server 40, device 20, and endpoint(s) 60 communicate via a communications network. This communications network can be made of any number of operably connected networks, including voice networks (e.g, PSTN (the established land-based telephone network)), data networks (e.g., intranets, the Internet, LANs, or WANs), and wireless voice or data networks (e.g., satellite, cellular, two-way paging, digital cellular (TDMA, CDMA, GSM or any other digital wireless protocol that may be developed)). Because of the interoperability of these networks, the interchangeability of voice and data, and the resultant transmission of data/voice between and through these various networks, the lines between them have blurred, merged, or may no longer exist. The term communications network therefore is used herein to refer to these networks and any other communications network capable of sending or receiving any information signal from one point to another point or points.

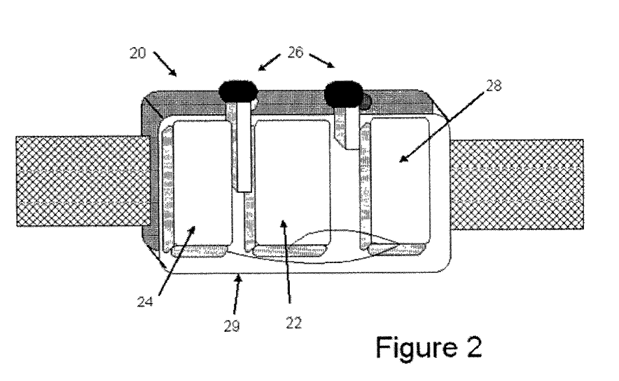

A schematic representation of the device 20 is shown in FIG. 2. The device 20 embodies a state-of-the-art GPS receiver 22 and one of several types of wide area data transceivers 24 (e.g., cellular, two-way paging, digital cellular (TDMA, CDMA or GSM), or any other appropriate digital transceiver). In most cases, firmware is embedded directly in the transceiver memory, and the transceiver has control logic to communicate with and monitor the GPS and its data stream, compare the current device location to a set of allowable locations based on time of day and day of week, as well as monitor and maintain network connectivity. In cases where commercially available transceivers are not sufficiently capable to perform such tasks, a single-board computer (sometimes referred to as a microcomputer) is used to act as a manager and mediator for the previously mentioned devices and data streams. The use and methods of programming of such microcomputers is well known in the art. Time is derived from the GPS data stream, and GMT offset is loaded into the firmware of wireless transceiver 24 or microcomputer as required. The GPS receiver 22 and wireless transceiver 24 receive and/or send signals via antenna 26. The device 20 is attached to the wearer via a monitored clip or belt device, such that removal of the device from the individual will cause an alert that may be transmitted via the communications network to a designated endpoint. The unit is protected from environmental conditions by a durable housing 29.

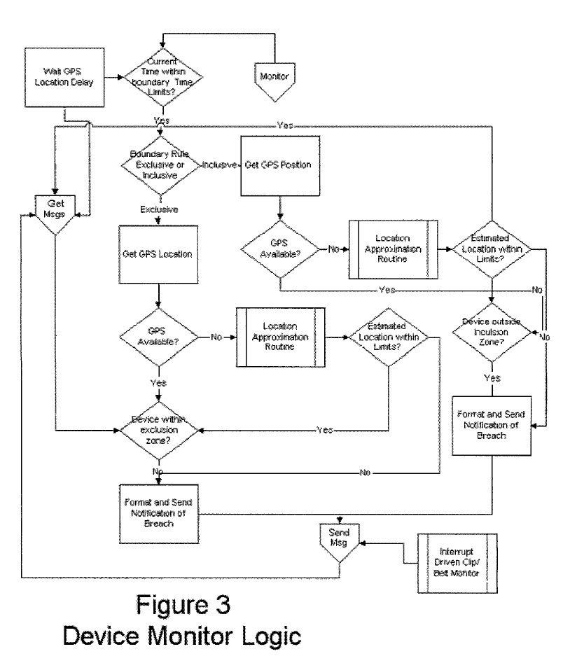

The boundary rule sets defined and stored within the remote device consist of either geographic boundaries that are stored as a series of latitudes and longitudes and interconnecting line segments or a single latitude/longitude marker and an allowed radius from the point. Any other known means of defining such boundaries, such as polar coordinates, may be employed. The geographic areas defined by such boundaries may be configured as either inclusion zones (i.e., the wearer should stay within the inclusion zone and crossing of a boundary to move outside of the inclusion zone triggers a breach), or exclusion zones (i.e., the wearer should stay outside of the exclusion zone and crossing a boundary into the zone triggers a breach), or a combination of the two. As noted, a boundary rule set may contain temporal components, such that the wearer should stay within or away from certain areas at a given time or day or the week. The boundary rule set within the device may be varied and updated dynamically in near real time by a user, as described below. The monitor logic of the device 20 is shown in FIG. 3.

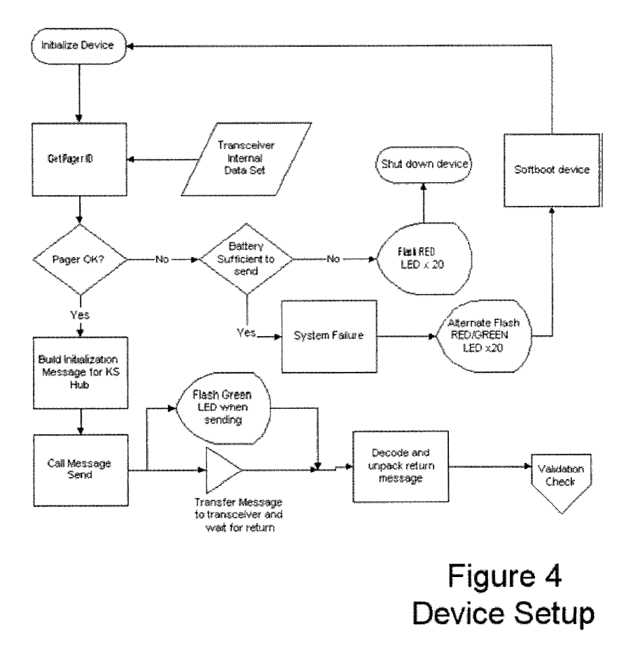

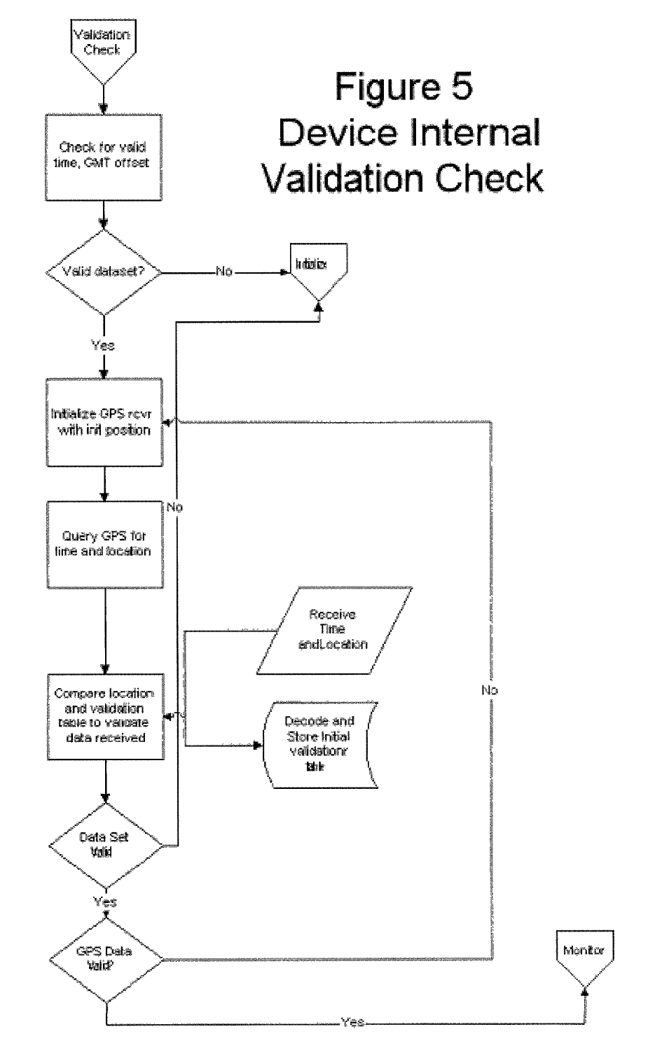

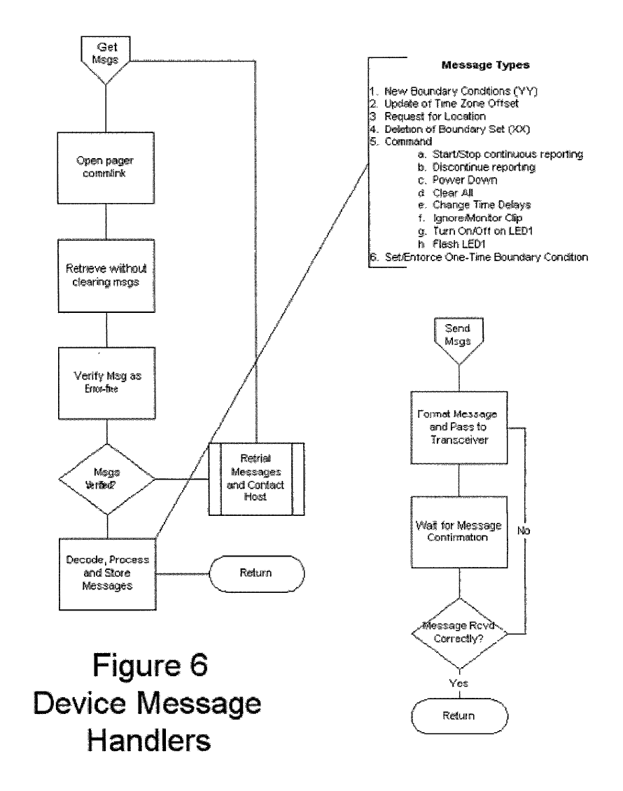

FIGS. 4-6 show the logic of the device setup, internal validation check, and message handlers, respectively. As shown in FIG. 4, the device 20 checks its battery status and transmits an initialization message to the server to notify it that the device 20 is powered on and to cause the server to communicate any updates to the boundary rule set or other messages (as described below) to the device. The device then enters into a validation check routine, as shown in FIG. 5, in which it determines its initial location and the time from the GPS signal and compares these values to validation data sets to validate that the system is operating correctly and that the location determined is not grossly erroneous. The validation data set may be loaded into the device over the air from the server as necessary. FIG. 6 shows the message handler logic as well as an exemplary list of message types that may be sent to the device 20.

Based on the device's movement history, the GPS receiver will be caused to update itself from the broadcast datastream on a periodic basis. Higher rates of movement (i.e., velocity) of the device will force more frequent updates of the GPS location, while lower rates require less frequent updates. The updates consequently may vary from as infrequent once every hour or longer to continuous or nearly continuous updating. The device stores in local RAM not less than the last five location updates, as well as the time of the update. Such variability in the rate of updates conserves battery power.

In particular areas or environments, the current state-of-the art GPS receiver either will not be capable of receiving sufficient satellite signal or incapable of receiving signal such that the GPS receiver will not be capable of deriving an accurate location. Instances in which the GPS satellite signals are attenuated, distorted, or effectively blocked include but are not limited to the wearer being inside a metal or concrete framed building, within a section of a city with high rise buildings, or underground. The device 20 compensates for this lack of accurate location data by estimating the current location based on the its last known location, and derived speed and direction from the previously stored way points. The device 20 indicates estimated position to the server 40 and/or querying endpoint 60 to indicate the GPS service has been interrupted. Likewise, the device 20 recognizes through an analysis of the received signal strength that it is either within a building or underground. Such conditions when coupled with boundary activation may force an assumption that the building is totally contained within the boundary condition and report based on that rule set.

The monitoring function of the device 20 should be clear from the foregoing and from FIG. 3. It may be summarized as follows. The device 20 updates its geographic location, including altitude, (and thus that of the wearer) from the GPS signals and stores these signals as described. The device 20 compares the current geographic location and time to the allowable geographic zones as defined by the stored boundary rule set. If the wearer 10 has breached the boundary rule set, the device 20 communicates notification of the breach to the server 40. The notification message contains at least one parameter of the breach, including time of day, day of week, geographic location of the wearer, altitude of the wearer, speed of the wearer's movement, and direction of the wearer's movement. The server receives the notification message and takes action as described below. The device 20 may be provided with LEDs and/or a speaker or buzzer to alert its wearer of the breach, or to communicate such other messages as necessary.

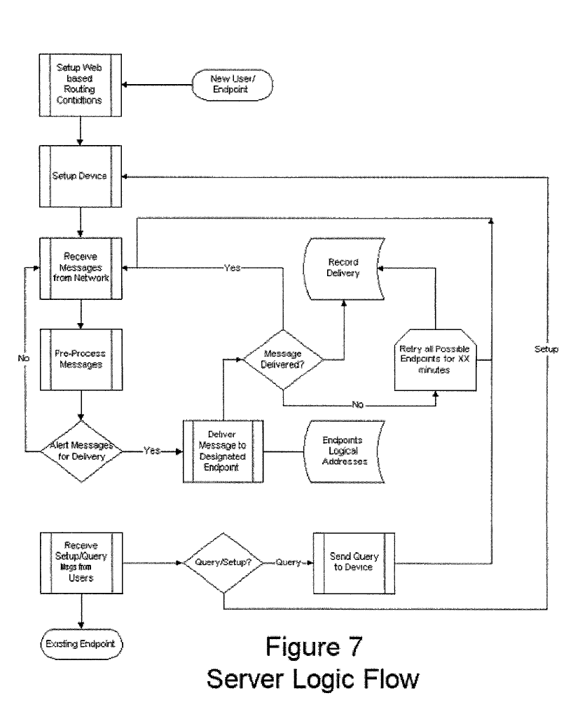

The server 40 is operably connected to the communications network and thus is capable of receiving and sending messages to the device 20. The server stores the logical identity of at least one endpoint 60, to which messages including notifications of breach of boundary rule sets are routed. The logical identity of an endpoint specifies its location or address and may vary according to the type of endpoint. The logical identity tells the server where to send the message. For example, logical identity of a pager or telephone may be a telephone number; of a computer or other internet appliance, an IP address; of a web page, a URL (uniform resource locator); of an email account, an email address; of the recipient of an Internet messaging service, a messaging user ID; and so on. The server logic flow is demonstrated in FIG. 7.

Associated with each endpoint is at least one routing condition that defines when that particular endpoint is designated to receive notification of breach of the boundary rule set by the wearer of the device. Routing conditions may include time of day, day of week, geographic location of the wearer, altitude of the wearer, speed of the wearer's movement, direction of the wearer's movemen, or a user-definable override condition. For example, a user may want to receive notification of a breach at a computer or email address at his or her place of business during the day, and at a home computer or home telephone in the evenings and on weekends. The routing conditions of various endpoints need not be mutually exclusive. The server can route notifications to one or more endpoints as user(s) of the system specify. The override condition is useful when the wearer or user will be temporarily departing from his or her normal schedule. The override condition typically has a given duration after which it will expire. In such cases, the presence of the override condition will cause all notifications to be sent to a specific endpoint for a given time. For example, the user may be traveling for a day or two, in which case the user could specify an override condition designating his or her wireless phone during that period of time, after which notifications will be sent according to the normal schedule. Again, although termed an “override” condition, the endpoint designated by such a condition need not be mutually exclusive to other endpoints.

A network-accessible communications center, such as an Internet website, may be made available to the system's users for the purposes of sending data to the server online and sending or receiving data or messages to and from the device. Systems and methods for uploading and downloading data to and from an a website are well known in the art and are not discussed here. It is also contemplated to provide a call center where users could speak to an operator to perform such steps if needed. Users thus may add or edit online the logical identity of endpoints, routing conditions associated with endpoints, and boundary rule sets to be communicated to the device 20. These actions are updated in the server in nearly real time, allowing dynamic variability of all definable aspects of the system from any internet connected device or a regular telephone via the call center. Users also may query the device 20 via the website to cause the device to communicate its current location or any other data stored in memory. Users may send messages to the device, or cause the device to display a certain light or sound signal. Users may also view data received from the device through the website, such as in the form of a scaled map showing the wearer's current location and history of movements. Boundary rule sets or other messages uploaded to the website are communicated via the server 40 through the communications network to the device 20 in nearly real time. This allows the rule sets to be updated dynamically by the user from any Internet connected device.

The device 20 is capable of displaying through a series of lights or sounds warnings or instructions to the wearer of the device. Such indications are ad hoc in nature and are established between the wearer and the user on an a priori basis. Such light or sound indications could be arranged to mean call home; come home; call me; or any other conceivable combinations. Likewise, in conjunction with a notification of a breach, the notice may include an interactive selection for the user to affect the wearer's device, either lighting lights, producing sounds, or actuating an interactive track and trace query.

It should be understood that the use of GPS and other specifically identified protocols or systems is exemplary and not exclusive. Such terms should be interpreted to include their permutations and equivalents known to those skilled in the art, as well as equivalent or replacement systems yet to be developed. For example, if a replacement to the current Global Positioning System is deployed, such replacement system may be employed by the present invention to provide geographic location data. Upon reading the foregoing disclosure, these and other variations would be apparent to those skilled in the art. Therefore, the present invention should be defined with reference to the claims and their equivalents, and the spirit and scope of the claims should not be limited to the description of the preferred embodiments contained herein.

1. A method of monitoring from a variable endpoint breaches of a boundary rule set by a remote wearer of a wireless communication device, said device capable of determining its current geographic location, storing said boundary rule set, comparing said current location to said rule set to determine if said wearer has breached said rule set, and communicating notification of said breach to a communications network, said method comprising:
storing in a server operably connected to said communications network the logical identity of at least one endpoint accessible through said network and at least one routing condition associated with each said endpoint;
receiving from said wireless communication device a notification of a breach including at least one parameter of said breach;
determining the endpoint designated to receive said notification based on said at least one parameter and the at least one routing condition stored in said server; and
communicating said notification to the designated endpoint.

2. The method of claim 1, wherein said at least one endpoint is selected from the group consisting of:
a. a pager;
b. a telephone;
c. a facsimile machine;
d. a personal digital assistant;
e. a computer;
f. a web page;
g. an electronic mail address; and
h. an internet messaging system.

3. The method of claim 1, wherein said at least one endpoint comprises an internet appliance.

4. The method of claim 1, wherein said at least one routing condition is selected from the group consisting of:
a. time of day;
b. day of week;
c. geographic location of the wearer;
d. altitude of the wearer;
e. speed of the wearer's movement;
f. direction of the wearer's movement; and
g. an override condition

5. The method of claim 1, wherein said at least one routing condition comprises an override condition.

6. The method of claim 4, wherein said at least one parameter is selected from the group consisting of:
a. time of day;
b. day of week;
c. geographic location of the wearer;
d. altitude of the wearer;
e. speed of the wearer's movement; and
f. direction of the wearer's movement.

7. The method of claim 1 wherein the at least one end point can send a message through said communications network to said wireless communication device without routing said message though said server.

8. The method of claim 7 wherein said message comprises a query of the device's current geographic location.

9. The method of claim 8 wherein said wireless communications device can communicate its current geographic location directly to the at least one end point through said communications network without routing said message though said server.

10. The method of claim 1 wherein a user access said server through said communications network and perform an action selected from the group consisting of:
a. adding the logical identity of a new endpoint;
b. editing the logical identity of an endpoint;
c. deleting the logical identity of an endpoint;
d. editing a routing condition associated with an endpoint;
e. editing the boundary rule set for the wireless communications device;
f. querying the wireless communications device for its current geographic location; and
g. sending a user-defined message to the wireless communications device.
